(19) United States
(12) Patent Application Publication
(10) Pub. No.: US 2022/0188757 A1
(43) Pub. Date: Jun. 16, 2022

(54) SYSTEMS AND METHODS FOR INVENTORY CONTROL AND OPTIMIZATION

(71) Applicant: Thrive Technologies, Inc., Marietta, GA (US)

(72) Inventor: Louis Rick Morris, Kennesaw, GA (US)

(21) Appl. No.: 17/552,091

(22) Filed: Dec. 15, 2021

Related U.S. Application Data
(60) Provisional application No. 63/125,756, filed on Dec. 15, 2020.

(51) Int. Cl. G06Q 10/08; G06Q 10/06; G06K 9/62

(52) U.S. Cl. CPC G06Q 10/087; G06K 9/6256; G06Q 10/06315

(57) ABSTRACT

The present systems and methods generally relate to optimizing inventory levels using machine learning methodologies. Using novel techniques, the present systems and methods can process and analyze inventory data to determine inventory items that are stocked out or overstocked and provide recommendations for mitigating these events, such that users can optimize their inventory levels with minimal manual intervention. For example, in various embodiments, the present systems and methods ingest inventory data, normalize and extract relevant portions of the inventory data, and sort the inventory data into one or more categories based on the root cause of any identified stockout or overstock events.

### CROSS REFERENCE TO RELATED APPLICATIONS

This application claims the benefit of, and priority to, U.S. Provisional Application No. 63/125,756, filed Dec. 15, 2020, and entitled “Systems and Methods for Inventory Control and Optimization,” which is incorporated herein by reference in its entirety.

### TECHNICAL FIELD

The present systems and methods relate generally to monitoring, managing, and optimizing inventory, and more particularly to identifying, classifying, and addressing root causes of distribution and retail inventory issues.

### BACKGROUND

In most industries that have inventory, there are often issues in determining the optimal levels of inventory to carry to satisfy upcoming sales, but without carrying expensive overstock which may never sell and will ultimately have to be liquidated. For example, in the distribution industry, lost sales data generated from dozens of distributors indicate that between five and ten percent of annual revenues are lost due to items being out of stock (e.g., “stockouts”). Additionally, distributors struggle with seven to twenty percent of their inventory being more than needed (e.g., “overstocked”) to cover a year of forecasted sales. Organizations that carry inventory attempt to address these inventory issues in various ways. In the example of stockouts, if they are selling specialty items, clients may be willing to wait until the item is back in stock. These organizations may also try to “rebalance” inventory if they have multiple selling locations. For example, midsized and large wholesale distributors attempt to counter inventory issues by having trucks run between their locations daily to move product around. However, this method of inventory control is inefficient and also incurs substantial cost.

For organizations that carry inventory, understanding why these inventory issues occur (i.e., root causes) has primarily been an anecdotal subjective exercise. The key challenge in understanding the root causes of these inventory issues is that there are multiple possible causes for these issues. Identifying which of the multiple possible causes for a specific inventory issue is rarely confidently understood. If organizations had an ability to know and understand specifically what is causing these inventory issues, they could then change processes to prevent or mitigate them. Thus, there exists an unresolved need for systems and methods that can identify and classify the reasons for inventory issues with a data driven, non-subjective approach.

### BRIEF SUMMARY OF DISCLOSURE

Briefly described, and according to one embodiment, aspects of the present disclosure generally relate to systems and methods for monitoring, managing, and optimizing inventory, and more specifically, to systems and methods for proactively identifying inventory issues and the underlying root cause of inventory issues. One such example of an inventory issue is a “stockout” which, as used herein, generally refers to depletion of a specific inventory item, for example, in a distribution environment, such that the item may be unavailable for purchase at the distribution environment for a period of time. Another example of an inventory issue is an “overstock,” which is typically defined differently for each organization but, as used herein, is generally considered more inventory than is needed for the foreseeable future. As may be used herein, a “stock event” generally refers to a stock out event (e.g., a stockout) and/or an overstock event (e.g., an overstock).

In various embodiments, the disclosed system provides a mechanism that allows for the automated identification and categorization of the root cause for a stockout. In some embodiments, the system may function to perform the below described operations on overstocks (i.e., surplus inventory) in addition to stockouts. Further, in at least one embodiment, the system may function to perform automatic classification of root causes of other inventory issues (e.g., obsolescence, spoilage, etc.). In further embodiments, the system may automatically generate alerts and/or recommendations for replenishing the out-of-stock item and/or avoiding future stockout or overstock events.

According to particular embodiments, the present disclosure generally describes a method of managing product inventory levels including: defining a plurality of categories of stock events; receiving a training dataset of inventory data, wherein the training dataset includes a plurality of items stocked or to be stocked with a particular entity; associating each of the plurality of items in the training dataset with a respective category of the plurality of categories of stock events; generating and training a machine learning model based on the training dataset of inventory data; receiving an evaluation dataset of inventory data, wherein the evaluation dataset includes a pre-associated category of stock events for each of the plurality of items; applying the machine learning model to the evaluation dataset of inventory data to generate an estimated category of stock events for each of the plurality of items; and comparing, for each of the plurality of items, the pre-associated category of stock events to the estimated category of stock events to determine an efficacy of the machine learning model.

In particular embodiments, the present disclosure describes the method herein, further including: receiving an operational dataset of inventory data, wherein the operational dataset includes a plurality of items stocked or to be stocked with a particular entity; and applying the machine learning model to the operational dataset of inventory data to associate each of the plurality of items in the operational dataset with a respective category of the plurality of categories of stock events. In one or more embodiments, aspects of the present disclosure describes the method herein, wherein the plurality of categories of stock events include: stockouts, overstocks or appropriately stocked. In some embodiments, the present disclosure describes the method herein, wherein one or more respective categories of the plurality of categories of stock events are associated with one or more reasons for the stock events. Generally, in certain embodiments, the present disclosure describes the method herein, wherein the efficacy is a measure of deviation between the pre-associated category of stock events to the estimated category of stock events, and an acceptable efficacy includes a margin of error below a predefined threshold for the deviation. In various embodiments, the present disclosure describes the method herein, wherein the particular entity includes a particular physical location, facility, company, or organization. In at least one embodiment, the present disclosure describes the method herein, wherein the plurality of categories include one of a first plurality of category subsets selected from the group including: stockouts; overstocks; and appropriately stocked. In particular embodiments, aspects of the present disclosure describe the method herein, wherein the first plurality of category subsets further include one of a second plurality of category subsets selected from the group including: replenishment orders for new items to be stocked with the particular entity made too late; one or more large unexpected customer sales depleted items stocked with the particular entity; undetected increases in demand of established items stocked with the particular entity; items stocked or to be stocked with the particular entity are low volume and difficult to forecast sales; purchase orders for items stocked or to be stocked are insufficient for strong seasonal pattern; purchase orders for items stocked or to be stocked are insufficient for promotions; late or short shipment of items to be stocked at particular location; new items stocked are selling more than forecasted; one or more items stocked were purchased in excess of forecast due to vendor minimums; one or more items stocked were purchased in excess of forecast due to vendor promotions; undetected decreases in demand of established items stocked with a particular entity; purchase orders for items stocked or to be stocked are packaged in quantities in excess of forecast; purchase orders for items stocked or to be stocked are overly ambitious for promotions; early or surplus shipment from vendor of items to be stocked at particular location; and new items stocked are selling less than expected.

According to various embodiments, the present disclosure generally describes a system for managing product inventory levels including: a database that stores inventory data; and a non-transitory computer readable medium that controls a processor that performs the steps of: defining a plurality of categories of stock events; receiving a training dataset of inventory data, wherein the training dataset includes a plurality of items stocked or to be stocked with a particular entity; associating each of the plurality of items in the training dataset with a respective category of the plurality of categories of stock events; generating and training a machine learning model based on the training dataset of inventory data; receiving an evaluation dataset of inventory data, wherein the evaluation dataset includes a pre-associated category of stock events for each of the plurality of items; applying the machine learning model to the evaluation dataset of inventory data to generate an estimated category of stock events for each of the plurality of items; and comparing, for each of the plurality of items, the pre-associated category of stock events to the estimated category of stock events to determine an efficacy of the machine learning model.

In particular embodiments, the present disclosure generally describe the system herein, wherein the processor is further configured for: receiving an operational dataset of inventory data, wherein the operational dataset includes a plurality of items stocked or to be stocked with a particular entity; and applying the machine learning model to the operational dataset of inventory data to associate each of the plurality of items in the operational dataset with a respective category of the plurality of categories of stock events. In some embodiments, the present disclosure generally describe the system herein, wherein the plurality of categories of stock events include: stockouts, overstocks or appropriately stocked. Aspects of the present disclosure generally describe the system herein, wherein one or more respective categories of the plurality of categories of stock events are associated with one or more reasons for the stock events. In certain embodiments, the present disclosure generally describe the system herein, wherein the efficacy is a measure of deviation between the pre-associated category of stock events to the estimated category of stock events, and an acceptable efficacy includes a margin of error below a predefined threshold for the deviation. In one or more embodiments, the present disclosure generally describe the system herein, wherein the particular entity includes a particular physical location, facility, company, or organization. In at least one embodiment, the present disclosure generally describe the system herein, wherein the plurality of categories include one of a first plurality of category subsets selected from the group including: stockouts; overstocks; and appropriately stocked. In some embodiments, the present disclosure generally describe the system herein, wherein the first plurality of category subsets further include one of a second plurality of category subsets selected from the group including: replenishment orders for new items to be stocked with the particular entity made too late; one or more large unexpected customer sales depleted items stocked with the particular entity; undetected increases in demand of established items stocked with the particular entity; items stocked or to be stocked with the particular entity are low volume and difficult to forecast sales; purchase orders for items stocked or to be stocked are insufficient for strong seasonal pattern; purchase orders for items stocked or to be stocked are insufficient for promotions; late or short shipment of items to be stocked at particular location; new items stocked are selling more than forecasted; one or more items stocked were purchased in excess of forecast due to vendor minimums; one or more items stocked were purchased in excess of forecast due to vendor promotions; undetected decreases in demand of established items stocked with a particular entity; purchase orders for items stocked or to be stocked are packaged in quantities in excess of forecast; purchase orders for items stocked or to be stocked are overly ambitious for promotions; early or surplus shipment from vendor of items to be stocked at particular location; and new items stocked are selling less than expected.

According to one or more embodiments, the present disclosure generally describes a method of managing product inventory levels including: receiving an operational dataset of inventory data, wherein the operational dataset includes a plurality of items stocked or to be stocked with a particular entity; retrieving a machine learning model, the machine learning model including a plurality of categories of stock events; applying the machine learning model to the operational dataset of inventory data to associate each of the plurality of items in the operational dataset with a respective category of the plurality of categories of stock events; and generating an output including results of the application of the machine learning model to the operational dataset.

In various embodiments, the present disclosure generally describe the method herein, further including: associating each of the plurality of items in the operational dataset with the respective category of the plurality of categories of stock events; and training the machine learning model based on the operational dataset of inventory data. In at least one embodiment, the present disclosure generally describe the method herein, wherein the efficacy is a measure of deviation between the pre-associated category of stock events to the estimated category of stock events, and an acceptable efficacy includes a margin of error below a predefined threshold for the deviation. In at least one embodiment, the present disclosure generally describe the method herein, wherein the stock events are selected from the group including: stockouts, overstocks and appropriately stocked. In some embodiments, aspects of the present disclosure generally describe the method herein, wherein one or more respective categories of the plurality of categories are associated with one or more reasons for stock events. In particular embodiments, the present disclosure generally describe the method herein, wherein the plurality of categories include one of a first plurality of category subsets selected from the group including: stockouts; overstocks; and appropriately stocked. In at least one embodiment, the present disclosure generally describe the method herein, wherein the first plurality of category subsets further include one of a second plurality of category subsets including the one or more reasons for stock events. In various embodiments, the present disclosure generally describe the method herein, wherein the one or more reasons for stock events are selected from the group including: replenishment orders for new items to be stocked with the particular entity made too late; one or more large unexpected customer sales depleted items stocked with the particular entity; undetected increases in demand of established items stocked with the particular entity; items stocked or to be stocked with the particular entity are low volume and difficult to forecast sales; purchase orders for items stocked or to be stocked are insufficient for strong seasonal pattern; purchase orders for items stocked or to be stocked are insufficient for promotions; late or short shipment of items to be stocked at particular location; new items stocked are selling more than forecasted; one or more items stocked were purchased in excess of forecast due to vendor minimums; one or more items stocked were purchased in excess of forecast due to vendor promotions; undetected decreases in demand of established items stocked with a particular entity; purchase orders for items stocked or to be stocked are packaged in quantities in excess of forecast; purchase orders for items stocked or to be stocked are overly ambitious for promotions; early or surplus shipment from vendor of items to be stocked at particular location; and new items stocked are selling less than expected. In some embodiments, aspects of the present disclosure generally describe the method herein, further including: retrieving the stock event reason for each of the plurality of items in the operational dataset; and generating a recommendation for resolving the stock event reason. In at least one embodiment, the present disclosure generally describe the method herein, further including: integrating with a third party ordering system and initiating an inventory order based on the recommendation generated. In some embodiments, the present disclosure generally describe the method herein, wherein the output includes a printable report or a display on a graphical user interface of a computing device.

According to particular embodiments, the present disclosure generally describes a system for managing product inventory levels including: a database that stores inventory data; and a non-transitory computer readable medium that controls a processor that performs the steps of: receiving an operational dataset of inventory data, wherein the operational dataset includes a plurality of items stocked or to be stocked with a particular entity; retrieving a machine learning model, the machine learning model including a plurality of categories of stock events; applying the machine learning model to the operational dataset of inventory data to associate each of the plurality of items in the operational dataset with a respective category of the plurality of categories of stock events; and generating an output including results of the application of the machine learning model to the operational dataset.

In various embodiments, the present disclosure generally describe the system herein, further configured for: associating each of the plurality of items in the operational dataset with the respective category of the plurality of categories of stock events; and training the machine learning model based on the operational dataset of inventory data. In at least one embodiment, the present disclosure generally describe the system herein, wherein the efficacy is a measure of deviation between the pre-associated category of stock events to the estimated category of stock events, and an acceptable efficacy includes a margin of error below a predefined threshold for the deviation. In certain embodiments, the present disclosure generally describe the system herein, wherein the stock events are selected from the group including: stockouts, overstocks and appropriately stocked. In at least one embodiment, the present disclosure generally describe the system herein, wherein one or more respective categories of the plurality of categories are associated with one or more reasons for stock events. In certain embodiments, aspects of the present disclosure generally describe the system herein, wherein the plurality of categories include one of a first plurality of category subsets selected from the group including: stockouts; overstocks; and appropriately stocked. In particular embodiments, the present disclosure generally describe the system herein, wherein the first plurality of category subsets further include one of a second plurality of category subsets including the one or more reasons for stock events. In several embodiments, the present disclosure generally describe the system herein, wherein the one or more reasons for stock events are selected from the group including: replenishment orders for new items to be stocked with the particular entity made too late; one or more large unexpected customer sales depleted items stocked with the particular entity; undetected increases in demand of established items stocked with the particular entity; items stocked or to be stocked with the particular entity are low volume and difficult to forecast sales; purchase orders for items stocked or to be stocked are insufficient for strong seasonal pattern; purchase orders for items stocked or to be stocked are insufficient for promotions; late or short shipment of items to be stocked at particular location; new items stocked are selling more than forecasted; one or more items stocked were purchased in excess of forecast due to vendor minimums; one or more items stocked were purchased in excess of forecast due to vendor promotions; undetected decreases in demand of established items stocked with a particular entity; purchase orders for items stocked or to be stocked are packaged in quantities in excess of forecast; purchase orders for items stocked or to be stocked are overly ambitious for promotions; early or surplus shipment from vendor of items to be stocked at particular location; and new items stocked are selling less than expected. In some embodiments, aspects of the present disclosure generally describe the system herein, wherein the processor is further configured for: retrieving the stock event reason for each of the plurality of items in the operational dataset; and generating a recommendation for resolving the stock event reason. In various embodiments, the present disclosure generally describe the system herein, wherein the processor is further configured for: integrating with a third party ordering system and initiating an inventory order based on the recommendation generated. In at least one embodiment, the present disclosure generally describe the system herein, wherein the output includes a printable report or a display on a graphical user interface of a computing device.

According to particular embodiments, the present disclosure generally describes a non-transitory computer-readable medium having program code that is stored thereon, the program code executable by one or more processing devices for performing operations including: defining a plurality of categories of stock events; receiving a training dataset of inventory data, wherein the training dataset includes a plurality of items stocked or to be stocked with a particular entity; associating each of the plurality of items in the training dataset with a respective category of the plurality of categories of stock events; generating and training a machine learning model based on the training dataset of inventory data; receiving an evaluation dataset of inventory data, wherein the evaluation dataset includes a pre-associated category of stock events for each of the plurality of items; applying the machine learning model to the evaluation dataset of inventory data to generate an estimated category of stock events for each of the plurality of items; and comparing, for each of the plurality of items, the pre-associated category of stock events to the estimated category of stock events to determine an efficacy of the machine learning model.

In one or more embodiments, the present disclosure generally describe the non-transitory computer-readable medium herein, further including: receiving an operational dataset of inventory data, wherein the operational dataset includes a plurality of items stocked or to be stocked with a particular entity; and applying the machine learning model to the operational dataset of inventory data to associate each of the plurality of items in the operational dataset with a respective category of the plurality of categories of stock events. In at least one embodiment, the present disclosure generally describe the non-transitory computer-readable medium herein, wherein the plurality of categories of stock events include: stockouts, overstocks or appropriately stocked. In some embodiments, the present disclosure generally describe the non-transitory computer-readable medium herein, wherein the efficacy is a measure of deviation between the pre-associated category of stock events to the estimated category of stock events, and an acceptable efficacy includes a margin of error below a predefined threshold for the deviation.

These and other aspects, features, and benefits of the claimed system will become apparent from the following detailed written description of the preferred embodiments and aspects taken in conjunction with the following drawings, although variations and modifications thereto may be effected without departing from the spirit and scope of the novel concepts of the disclosure

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary system environment, according to one embodiment of the present disclosure.

FIG. 2 illustrates an exemplary system architecture, according to one embodiment of the present disclosure.

FIG. 3 illustrates an exemplary inventory optimization machine learning model initiation process, according to one embodiment of the present disclosure.

FIG. 4 illustrates an exemplary inventory optimization machine learning model training process, according to one embodiment of the present disclosure.

FIG. 5 illustrates an exemplary inventory optimization machine learning model operational process, according to one embodiment of the present disclosure.

FIG. 6 illustrates an exemplary comprehensive alternate machine learning inventory optimization process, according to one embodiment of the present disclosure.

FIG. 7 illustrates an exemplary data schema, according to one embodiment of the present disclosure.

FIG. 8 illustrates an exemplary user interface home screen, according to one embodiment of the present disclosure.

FIG. 9 illustrates an exemplary user interface, according to one embodiment of the present disclosure.

FIGS. 10A and 10B illustrate exemplary user interfaces, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Briefly described, and according to one embodiment, aspects of the present disclosure generally relate to systems and methods for monitoring, managing, and optimizing inventory, and more specifically, to systems and methods for proactively identifying inventory issues and the underlying root cause of inventory issues. One such example of an inventory issue is a “stockout” which, as used herein, generally refers to depletion of a specific inventory item, for example, in a distribution environment, such that the item may be unavailable for purchase at the distribution environment for a period of time. Another example of an inventory issue is an “overstock,” which is typically defined differently for each organization but, as used herein, is generally considered more inventory than is needed for the foreseeable future. As may be used herein, a “stock event” generally refers to a stock out event (e.g., a stockout) and/or an overstock event (e.g., an overstock).

In various embodiments, the disclosed system provides a mechanism that allows for the automated identification and categorization of the root cause for a stockout. In some embodiments, the system may function to perform the below described operations on overstocks (i.e., surplus inventory) in addition to stockouts. Further, in at least one embodiment, the system may function to perform automatic classification of root causes of other inventory issues (e.g., obsolescence, spoilage, etc.). In further embodiments, the system may automatically generate alerts and/or recommendations for replenishing the out-of-stock item and/or avoiding future stockout or overstock events.

In one non-limiting discussion example , a need arises where an entity (e.g., a retailer, wholesaler, manufacturer, etc.) wants to improve its inventory performance. The entity may already use an inventory replenishment system to manage inventory levels, however, the systems and methods described herein can, in one embodiment, work with inventory replenishment systems to facilitate a better understanding and control of inventory issues, such that causes of the inventory issues are identified and can be corrected. For example, a distribution buyer may commonly buy multiple inventory items from the same vendor. They may also commonly have a minimum quantity to buy from the vendor (e.g., the vendor pays for shipping if the distribution buyer places a purchase order (“PO”) of at least $2,000). It often occurs that at a time when items from the vendor are stocking out, the distribution buyer may delay placing a PO because the suggested PO is well below the $2,000 freight minimum. Consequently, by the time the distribution buyer eventually places the PO, the requested item (or items) is stocked out at the vendor. This is a very common reason why items stock out for distribution companies. However, there is no current system that can tell distribution company that this was the reason for the stockout on specified items and/or can attach a dollar cost to this situation. If the distribution company had this information, they may discover that it is worth the shipping cost to place PO's for certain vendors when certain items are running out of stock, as opposed to waiting for an incentive (e.g.,. free shipping) to place the next order.

Numerous other examples exist and are contemplated by aspects of the present disclosure. In various embodiments, the system includes one or more data models to facilitate categorization of stockouts and overstocks. In particular embodiments, the system includes a data model to facilitate categorization of stockouts and overstocks. In various embodiments, the data model includes a list of all stockout and overstock events and supporting data (e.g., for a particular distribution location or customer, or for a given market segment, or any retailer globally, etc.). In certain embodiments, the supporting data may include, but is not limited to: the start and stop date of the stockout or overstock event, the number of business and/or calendar days on which the stockout or overstock event occurred, the item that was stocked out or overstocked, the location (e.g., Atlanta Warehouse One) of the item that was stocked out or overstocked, the most recent purchase order (“PO”) for the stocked out or overstocked item (if available), the most recent forecast for the stocked out or overstocked item (if available), and other data as will occur to one of ordinary skill in the art. As used herein, the terms “stockout event” and “overstock event” generally may be used interchangeably with the terms “stockout” and “overstock,” respectively.

In one embodiment of the present systems and methods, inventory data is collected from a distribution establishment. In various embodiments, the inventory data may be collected by a third party inventory replenishment system (or other suitable system, such as an Enterprise Resource Planning (“ERP”) system). In certain embodiments, the inventory data may be manually entered into the system. In some embodiments, the collected data is processed and analyzed to identify past inventory issue events and categorize those events into one or more pre-defined categories. In particular embodiments, the processed data is then used to generate a machine learning model, such that new inventory issue events may be automatically identified and categorized (in some embodiments, the categorization can occur in real time). In these embodiments (and others), understanding the category of an inventory issue may allow for process adjustments to possibly prevent future inventory issues from occurring.

In certain embodiments, the system is configured to receive a data model as input. In at least one embodiment, the system employs artificial intelligence and machine learning to learn a mapping from input (e.g., inventory issue contextual information) to output (e.g., inventory issue category) based on a set of example input-output pairs (i.e., the “training dataset”). In these embodiments (and others), the system is configured to receive input data about a new inventory issue event in the form of the data model, and use that input data to categorize the inventory issue event. In various embodiments, the training set may also include labels of example inventory issues, whereby each inventory issue event includes a label of the correct inventory issue category to facilitate training the system based on one or more machine learning methodologies as further described herein. In particular embodiments, the system may receive labels via any suitable method, including but not limited to: user and/or admin input, third party data extraction, etc.

Accordingly, as described above, aspects of the various embodiments described herein will train a given data model based on many prior inventory issue events and the data relating thereto. This often requires categorization of the prior inventory issue events (usually through manual categorization and analysis of the data). The model is trained based on these prior inventory issue events and the known reasons for the same to identify determining and probabilistic factors (root causes) that lead to a given inventory issue. Once trained, the model can be used for a given organization to track and identify the cause of any inventory issue event.

Additionally, in further embodiments, the present system may integrate with traditional ordering systems or inventory control systems to automatically place orders on behalf of a given supplier, retailer, or other customer. For example, if the system identifies an immediate need for a given product because a stockout event is imminent, then rather than providing a recommendation to the end user and awaiting the user to manually create an order, the system can instead provide an instruction to the connected inventory control or ordering system to automatically place the determined order. In one embodiment, such automatic ordering can be controlled by various, predefined user parameters, such as only allowing orders within a certain size threshold, or under a given dollar amount, or of certain products, etc. These types of controls can be used to ensure large or unexpected orders are avoided. That said, use of real-time data monitoring and automatic ordering can help avoid many unwanted stockouts in a supplier or retailer environment.

The present disclosure is not limited to, and does not distinguish between, any particular types of inventory. In one embodiment, the inventory can be raw materials or component parts. In another embodiment, the inventory can be finished products for retailing or wholesaling. In yet another embodiment, the inventory can be maintenance, repair, and operations goods. In yet another embodiment, the inventory can be works in in progress. In various embodiments, the inventory can be service inventory, transit inventory, or any other inventory that can be counted, tracked, and monitored.

### EXEMPLARY EMBODIMENTS

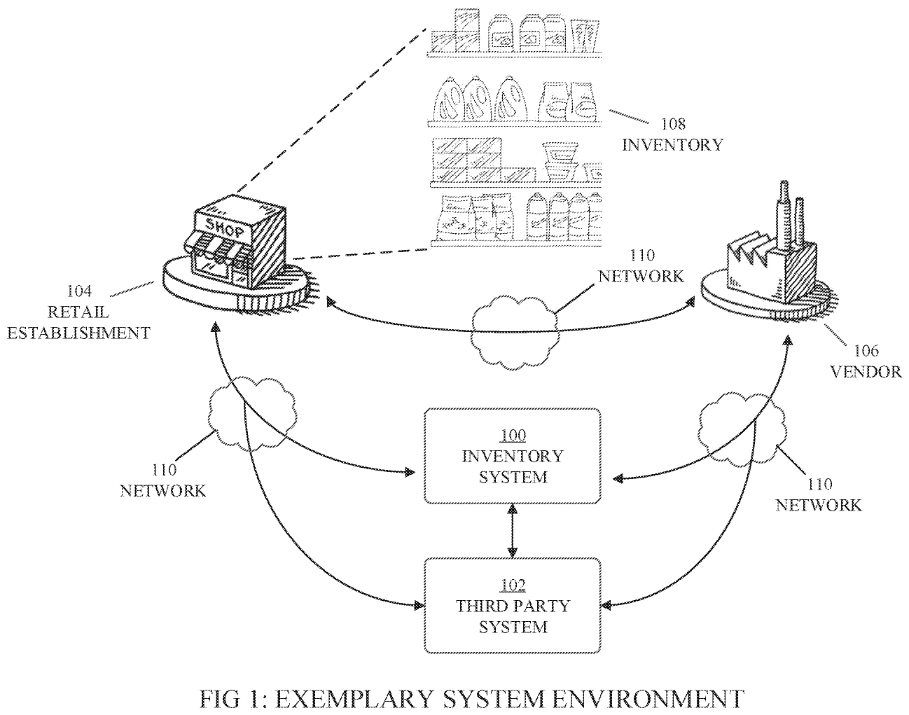

Referring now to the figures, for the purposes of example and explanation of the fundamental processes and components of the disclosed systems and methods, reference is made to FIG. 1, which illustrates an exemplary, high-level overview of one embodiment of the systems and methods herein. As will be understood and appreciated, the exemplary, high-level overview shown in FIG. 1 represents merely one approach or embodiment of the present system, and other aspects are used according to various embodiments of the present system. In particular, FIG. 1 depicts a particular example where a retail establishment 104 uses an embodiment of the disclosed inventory system 100 to optimize inventory 108 received from a vendor 106. Further, FIG. 1 depicts how various systems in this environment interact in at least one embodiment of the systems and methods described herein.

FIG. 1 depicts an example in which a retail establishment 104 employs the inventory system 100 disclosed herein to manage its inventory 108 and limit the likelihood of having stockout or overstock issues. In particular embodiments, the inventory system 100 is accessed via a computing device (e.g., smartphone, desktop computer, tablet computer, etc.). In certain embodiments, the inventory system 100 includes a database in which the retail establishment 104 can store information pertaining to its inventory 108. In various embodiments, the information stored may include, but is not limited to: type of inventory, product name, product description, quantity, location, days on hand, price, cost, number of units sold, last stockout event, last overstock event, lead time for replenishment, historical inventory data, and any other suitable information relevant to the systems and methods described herein. In certain embodiments, the inventory system 100 may obtain information pertaining to the retail establishment's 104 inventory from a third party system 102. In particular embodiments, the third party system 102 may be an Enterprise Resource Planning (“ERP”) system or other suitable inventory management system. In one or more embodiments, the inventory system 100 may be connected to the third party system 102 via FTP, database sharing (e.g., SQL, virtual, etc.), custom API integration, or other suitable connectivity method. Further, as shown, the various components of this exemplary environment are operatively connected via one or more networks 110.

In one embodiment, the network 110 may be, but is not limited to the Internet, and may involve the usage of one or more services (e.g., a Web-deployed service with client/service architecture, a corporate Local Area Network (LAN) or Wide Area Network (WAN), a cellular data network, or through a cloud-based system). Moreover, as will be understood and appreciated by one having ordinary skill in the art, various networking components like routers, switches, hosts, etc. are typically involved in these communications. Although not shown in FIG. 1, such communications may include, in various embodiments, one or more secure networks, gateways, or firewalls that provide additional security from unwarranted intrusions by unauthorized third parties and cyber-attacks.

In at least one embodiment, using the obtained inventory information, the inventory system 100 may identify inventory items that are stocked out or overstocked, at risk of being stocked out or overstocked, or have been stocked out or overstocked within a predetermined time period (e.g., within thirty days, ninety days, six months, etc.). In these embodiments (and others), using machine learning methodologies, the inventory system 100 may sort the identified stocked out or overstocked items into various categories of potential reasons (e.g., root causes) for which the items are stocked out or overstocked. For example, the inventory system 100 may determine that the retail establishment 104 is stocked out of a specialty brand of color-safe bleach. In various embodiments, the inventory system 100 may process and analyze the inventory information to determine that the color-safe bleach is stocked out because a replenishment purchase order was made too late to cover the intermediary demand.

In particular embodiments, the system may categorize causes of stockouts and overstocks into one or more categories based on contextual information associated with a stockout or overstock. In some embodiments, additional reasons for inventory issues may include severe weather issues, special events, etc. As will be understood and appreciated, other reasons for inventory issues (e.g., stockouts, overstocks, etc.) may exists in various environments; the reasons described herein are provided for illustrative and exemplary purposes only, and are not intended to limit the scope of the present disclosure in any way. In at least one embodiment, high-level reasons for a stockout or overstock may be broadly categorized as: 1) stockout or overstock caused by buyer error; 2) stockout or overstock caused by supplier error; and/or 3) stockout or overstock caused by forecasting error. In various embodiments, in addition to replenishment purchase orders being made too late (number one in the following list), additional reasons for stockouts may include, but are not limited to: 2) one or more large unexpected customer sales depleted inventory; 3) undetected increases in demand of established items; 4) items are low volume and difficult to forecast sales; 5) insufficient stock purchases for strong seasonal pattern; 6) insufficient stock purchases for promotions; 7) late or short shipment from vendor; and/or 8) new items are selling more than forecasted. Similarly, in at least one embodiment, the system may categorize overstocks into at least the following reasons: 1) excess inventory purchased due to Vendor Minimum; 2) Vendor offered “deal” or discount which caused excess purchase; 3) undetected decreases in demand of established items; 4) items are low volume and difficult to forecast sales; 5) Pack size (e.g., case of 100) caused excess purchase (e.g., only needed 3 units); 6) overly ambitious stock purchases for promotions; 7) early or surplus shipment from vendor; and/or 8) new items are selling less than expected.

In particular embodiments, the inventory system 100 may be configured to communicate with a vendor to adjust purchase orders based on the classification of identified stockouts or overstocks. Continuing with the above example, upon determining that the color-safe bleach was stocked out because replenishment purchase orders were made too late, the inventory system 100 initiates a communication with the vendor of the color-safe bleach to place an immediate order for the bleach and to adjust the timing of future purchase orders to eliminate the likelihood of a future stockout event for this item. In some embodiments, the inventory system 100 may communicate with the vendor 106 via email or direct messaging. In one or more embodiments, the inventory system 100 may integrate with the vendor's 106 inventory system to automatically place an order or to schedule/adjust future orders. In certain embodiments, the inventory system 100 is configured to issue a notification to the retail establishment 104 such that the retail establishment 104 can communicate with the vendor 106 to place an order or schedule/adjust future orders.

As will be understood from the discussions herein, the above particular example is merely exemplary functionality of the systems and methods described herein. For example, the above describes a stockout event pertaining to a specialty brand of color-safe bleach, but the systems and methods herein may be useful for any use in connection with determining the root cause of a stockout or overstock event. Alternate examples may include identifying the reason several cases of a perishable food product were unsold and ultimately discarded for spoiling; or determining why a high-performance car part was out of stock during the early months of racing season, or any other number of examples. The above mentioned alternate examples are merely exemplary functionality and are not meant to limit the scope of this disclosure.

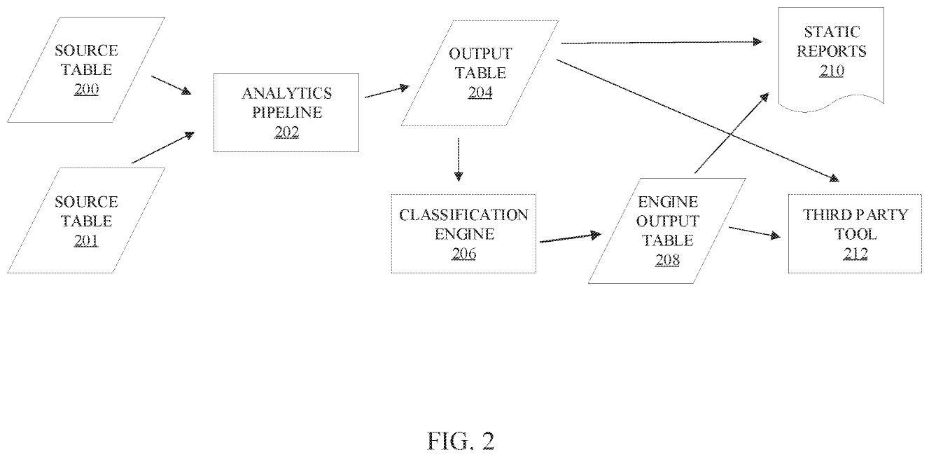

Turning now to FIG. 2, an exemplary system architecture of the inventory system 100 is shown, according to one embodiment of the present disclosure. In one or more embodiments, the system may include one or more source tables 200, 201. In some embodiments, the one or more source tables 200, 201 include inventory information ingested into the system. In particular embodiments, inventory information may be ingested into the system from a third party inventory management system. In some embodiments, inventory information may be manually entered into the system. In some embodiments, the inventory information may be sourced from any suitable database (e.g., user database, third-party database, remote server, virtual server, etc.). In various embodiments, the inventory information includes stockout or overstock data (e.g., date of stockout or overstock event, last fulfilled order, next scheduled order, last sale, etc.) for each item included in the inventory information. In one or more embodiments, the source tables 200, 201 may include data from several data sources. In some embodiments, the source tables may include data from any suitable number of data sources (e.g., one, five, seven, twelve, twenty-five, etc.). In certain embodiments, the data sources may include, but are not limited to: master data on inventory items at each location; a history of purchase orders placed per item per location; a history of purchases made by customers of each inventory item per location; a history of key events (e.g., stockouts and overstocks) per item per location; forecast history of inventory items at each location; and a history of items in each location.

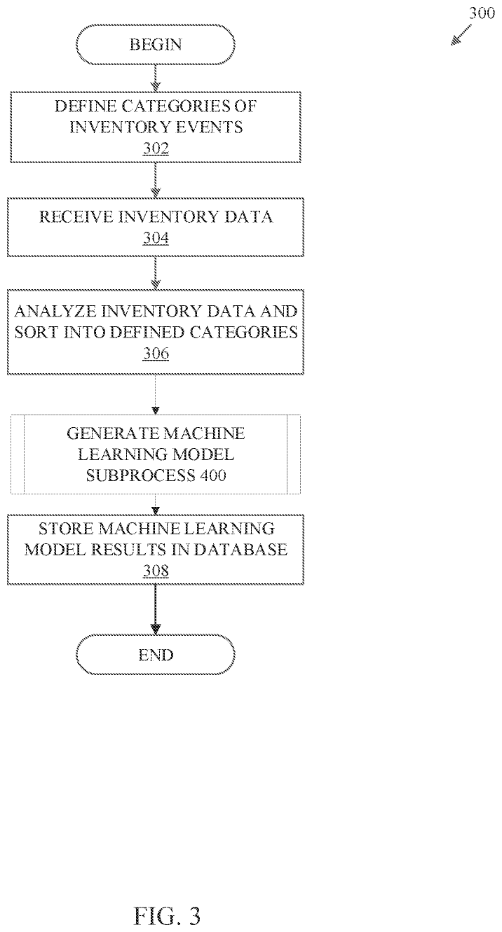

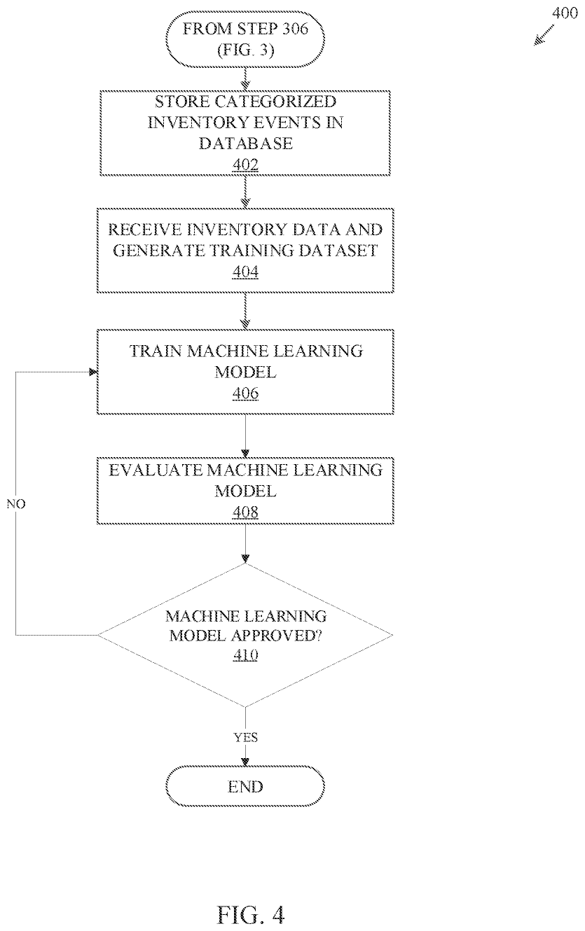

In certain embodiments, the system may also include an analytics pipeline 202. In these embodiments (and others), the analytics pipeline 202 processes the data ingested from the source tables 200, 201 such that the data is compatible with the inventory system 100. In particular embodiments, the data is cleaned (e.g., normalized) to remove any extraneous information and reformatted into a standard form that the system can process and on which it can perform additional operations. In particular embodiments, feature extraction also occurs in the analytics pipeline 202. In various embodiments, feature extraction refers to the system converting the cleaned data into a set of features (e.g., inputs) suitable for the machine learning model. In various embodiments, the set of features may include PO issue date, PO receipt date, daily on hand units value, forecast quantity by day, vendor minimum, etc. In at least one embodiment, the set of features include stockout and/or overstock data. In particular embodiments, and as will be further discussed below in relation to FIG. 3, the inventory data is sorted into one or more predefined categories. In certain embodiments, the one or more predefined categories generally comprise reasons for inventory stockout or overstock events as discussed above in relation to FIG. 1. In certain embodiments, the inventory data is manually sorted in the analytics pipeline 202. In at least one embodiment, the inventory data is automatically sorted based on one or more machine learning methodologies.

In particular embodiments, the analytics pipeline 202 outputs the processed data (e.g., normalized, feature extracted, and sorted data) to an output table 204. In particular embodiments the output table 204 stores and/or displays the resulting data upon passing through the analytics pipeline 202. In particular embodiments, the output table 204 may include at least the inventory data and the category associated with each item of inventory. In certain embodiments the output table 204 may be printed and/or displayed on a user's computing device (e.g., tablet computer, smartphone, desktop computer, etc.) in the form of a static report 210 such that the user can visually assess the results. In various embodiments, the output table 204 may be transmitted to a third-party inventory tool 212 (e.g., a business intelligence system) for further processing and analytics.

In one or more embodiments, the output table 204 is transmitted to a classification engine 206 for further processing. In various embodiments, the classification engine 206 employs one or more machine learning methodologies to classify (e.g., sort) the inventory data according to the various categories of root causes of inventory stockout and overstock events. In certain embodiments, the machine learning methodologies employed by the classification engine 206 may include, but are not limited to: multiclass classification algorithms (e.g., multiclass logistic regression, multiclass neural network, multiclass decision forest, one-vs-all multiclass, multiclass boosted decision tree, etc.), latent Dirichlet allocation (LDA); term frequency—inverse document frequency (TF-IDF); k-means clustering; and any other algorithm suitable to perform the functions described herein.

In some embodiments, the classification engine 206 may classify the inventory data in two stages. In various embodiments, during the first stage of classification, an inventory item may be classified as “stocked out”, “overstocked”, or “appropriately stocked.” In particular embodiments, the results of the first classification stage is stored in a database.

In one or more embodiments, during the second stage of classification, an inventory item classified as “stocked out” in the first stage may be further classified as: 1) replenishment purchase orders being made too late; 2) one or more large unexpected customer sales depleted inventory; 3) undetected increases in demand of established items; 4) items are low volume and difficult to forecast sales; 5) insufficient stock purchases for strong seasonal pattern; 6) insufficient stock purchases for promotions; 7) late or short shipment from vendor; and/or 8) new items are selling more than forecasted.

In particular embodiments, during the second stage of classification, an inventory item classified as “overstocked” in the first stage may be further classified as: 1) excess inventory purchased due to Vendor Minimum; 2) Vendor offered “deal” or discount which caused excess purchase; 3) undetected decreases in demand of established items; 4) items are low volume and difficult to forecast sales; 5) Pack size (e.g., case of 100) caused excess purchase (e.g., only needed 3 units); 6) overly ambitious stock purchases for promotions; 7) early or surplus shipment from vendor; and/or 8) new items are selling less than expected.

In certain embodiments, the classification engine 206 performs additional analysis on the classified inventory data. In these embodiments (and others), the classification engine 206 may assess the historical data of each inventory item and determine a recommended action for correcting the stockout and overstock events. In various embodiments, the system may recommend purchase orders, forecast adjustments, inventory transfers (between locations), price adjustments, and other similar recommendations In one embodiment, an exemplary recommendation may include the system paying freight costs for a particular vendor to reduce lost sales. In another embodiment, an exemplary recommendation may include the system employing additional analysis on proposed vendor deals to mitigate the risk of overstocks.

In one or more embodiments, the classification engine 206 outputs the classified data (and associated recommendations) to an engine output table 208. In particular embodiments the engine output table 208 stores and/or displays the resulting data upon passing through the classification engine 206. In particular embodiments, the engine output table 208 may include at least the inventory data and the category associated with each item of inventory. In various embodiments, the engine output table 208 may include one or more recommended actions for correcting one or more identified stockout or overstock events and mitigating and/or eliminating future inventory issue occurrences based on the identified root cause. In certain embodiments the engine output table 208 may be printed and/or displayed on a user's computing device (e.g., tablet computer, smartphone, desktop computer, etc.) in the form of a static report 210 such that the user can visually assess the results. In various embodiments, the engine output table 208 may be transmitted to a third-party inventory tool 212 for further processing and analytics. In at least one embodiment, the engine output table 208 may be transmitted back to the source tables 200, 201 such that the inventory data may be recycled back through the analytics pipeline 202 to facilitate evaluation and adjustment of the machine learning methodology employed.

Turning now to FIG. 3, an exemplary inventory optimization machine learning model initiation process 300 is shown, according to one embodiment of the present disclosure. More specifically, the embodiment shown in FIG. 3 shows a process for initiating an embodiment of the machine learning inventory optimization system described herein. In various embodiments, and as will be understood by a person having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown.

As shown in FIG. 3, the exemplary process begins with step 302, in which the system is configured to define categories of inventory events. In particular embodiments, the categories defined pertain to the type of inventory event (e.g., stockout or overstock). In these embodiments (and others), the type of inventory event is further categorized into one or more reasons for a stockout or overstock as discussed above in relation to FIG. 2. In certain embodiments, the categories may be defined manually by a user of the system via a user interface that allows the user to interact with the system. In various embodiments, the system may automatically define the categories of inventory events based on inventory data as may be received and processed by the system.

At step 304, the system receives inventory data. In various embodiments, the inventory data may be manually entered into the system by a user (e.g., system administrator) via the user interface. In particular embodiments, the system may receive the inventory data from a third-party inventory management tool (e.g., an ERP tool). In these embodiments (and others), the system is configured to interface with various third-party applications via API integrations and/or various file sharing techniques (e.g., FTP transfers, cloud sharing, etc.). In one or more embodiments, if the inventory data is received from a third-party system, the data may be parsed and normalized prior to processing. In certain embodiments, the inventory data received by the system may be inventory data that was processed and output by the system and subsequently fed back into the system for additional processing. In at least one embodiment, the inventory data received by the system includes, but is not limited to: inventory type, product name, product description, quantity, location, days on hand, price, cost, number of units sold, last stockout event, last overstock event, lead time for replenishment, historical inventory data, and any other suitable information relevant to the systems and methods described herein. In one embodiment, the inventory data may be for a single user (e.g., a distributor). In another embodiment, the inventory data may be for a group of multiple users (e.g., several distributors). In certain embodiments, inventory data may be aggregated to assess various stockout and overstock trends and statistics (e.g., industry trends, geographic trends, etc.)

At step 306, the system is configured to analyze the inventory data received at step 304 and sort the inventory data into the categories defined at step 302. In one or more embodiments, the inventory data may be manually sorted by a user (e.g., system administrator). In particular embodiments, the system may assess the inventory data to first determine whether each inventory item is a stockout or an overstock. In these embodiments (and others), the system may analyze the item count and historical sales figures to facilitate this initial sort (e.g., if the stock count is zero and sales have been consistent over a predefined period of time (e.g., one month, three months, six months, etc.), then the system sorts the inventory item into the “stocked out” category; or if the stock count is greater than a predefined “time supply” of inventory (e.g., six months of forecasted demand, twelve months of forecasted demand, etc.) and a sale has not been registered in a predefined period of time (e.g., one month, three months, six months, etc.), then system sorts the inventory item into the “overstocked” category). In various embodiments, the system analyzes a variety of facets of the inventory data to determine whether each inventory item is a stockout or an overstock. In certain embodiments, the system may assess the inventory data and determine that one or more inventory items are neither stockouts or overstocks, but are appropriately stocked (e.g., the stock levels are satisfactory for the forecasted sales volume).

In one or more embodiments, once the system determines whether each item of inventory is a stockout or an overstock (or neither), the system is configured to then determine the reason that each inventory item is stocked out or overstocked and then sort the inventory item into the appropriate category (as defined and discussed above in relation to FIGS. 1 and 2). In some embodiments, the inventory data may be manually sorted by a system administrator. In particular embodiments, the classification engine (discussed above in relation to FIG. 2) facilitates the inventory sorting. In particular embodiments, the classification engine is configured to analyze the inventory data (e.g., sales volume, customer size, customer purchase volume, time and date of sales, price of inventory, price changes, etc.) and determine the root cause of the stockout or overstock event based on its analysis. The inventory data listed above is not exhaustive of the inventory data assessed by the classification engine and is not meant to limit this disclosure but is included for exemplary purposes. In particular embodiments, if the inventory data was not manually sorted, the system is configured to receive confirmation by a system administrator (e.g., a user) that the inventory data was appropriately and accurately sorted.

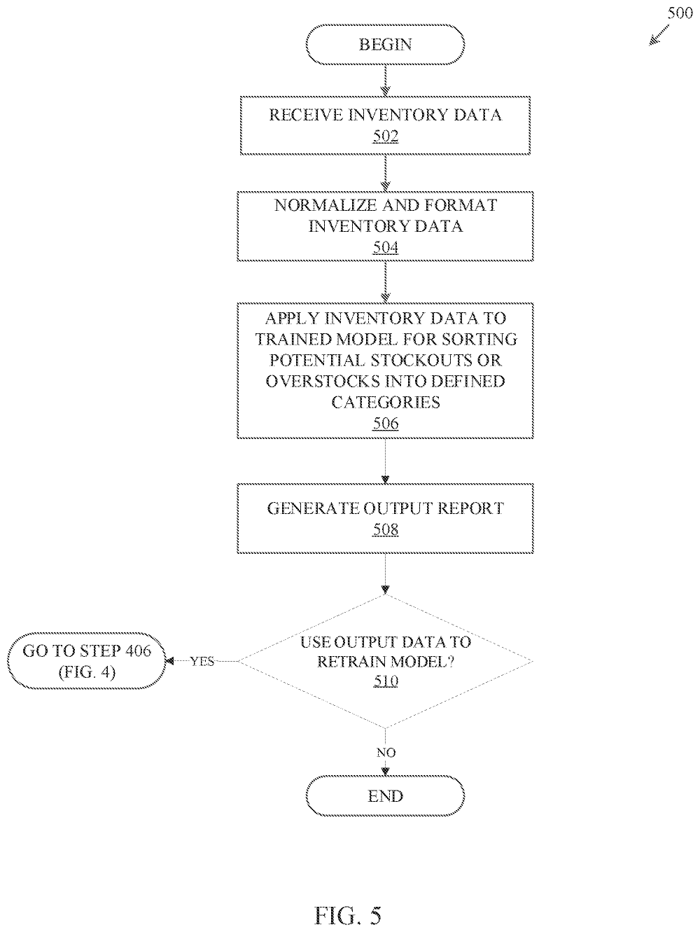

In at least one embodiment, once the inventory data is analyzed and sorted into the one or more defined categories, the system is configured to generate and perform a machine learning subprocess 400 (described in greater detail below). In certain embodiments, the machine learning subprocess 400 generally includes training a machine learning model based on the inventory classifications discussed above, re-categorizing the inventory data based on the trained model, and evaluating the results of the re-categorization, as described below in the discussion of FIGS. 4.

Continuing with the exemplary machine learning inventory optimization process shown in FIG. 3, at step 308, the system stores the machine learning model results in a database.

Now referring to FIG. 4, an exemplary inventory optimization machine learning model training subprocess 400 is shown, according to one embodiment of the present disclosure. In various embodiments, the exemplary process 400 begins at step 402, where the system is configured to store the results of the initial inventory sort performed at step 306 (from FIG. 3) in a database.

At step 404, the system receives inventory data and generates a training dataset based on the received data. In particular embodiments, the system is configured to parse and normalize the inventory data to facilitate generation of the training dataset. In various embodiments, the system normalizes the data by removing extraneous information and formatting the data into a standard form that may be understood and processed by the system. In some embodiments, the system performs feature extraction on the normalized inventory data to convert the data into a set of inputs (e.g., features) suitable for training the machine learning model. In at least one embodiment, the set of features include stockout and/or overstock data. In particular embodiments the system may include more than one training dataset. In some embodiments, the system may generate a training dataset for each category of inventory defined in the system. In these embodiments (and others), generating multiple training datasets provides the classification engine with multiple data points to process to facilitate improved learning and more accurate classifications. In one or more embodiments, generating multiple training datasets also facilitates evaluation of the model via an evaluation set (as will be further described herein).

At step 406 the system is configured to train the machine learning model using the training datasets generated at step 404. In various embodiments, the system is trained to classify the inventory data into one or more defined categories. In particular embodiments, the system ingests the training datasets to facilitate training. In certain embodiments, the system is trained to conduct a first sort into a first set of distinct categories and a second sort into a second set of distinct categories. In one or more embodiments, the system is trained to conduct a first sort of the training datasets into two or more categories. In particular embodiments, the system is trained to conduct a first sort of the training datasets into three categories: “stocked out,” “over stocked,” and “appropriately stocked.” In various embodiments, the system's classification engine analyzes the inventory data (e.g., inventory count, sales volume, transaction history, etc.) of the training dataset to facilitate sorting the training dataset into one of the three categories described above. In at least one embodiment, the training dataset may be manually sorted into one of the three categories described above. In certain embodiments, the system is configured to store the results of the first sort in a database.

In particular embodiments, the system is configured to conduct a second sort of the training dataset into a second set of distinct categories. In various embodiments, the system may conduct the second sort using the results of the first sort of the training dataset. In these embodiments (and others), the system is configured to conduct the second sort using the training dataset values classified as “stocked out” and “overstocked.” In at least one embodiment, the system is configured to determine the root cause for each item of inventory in the training dataset classified as “stocked out” or “overstocked.” In certain embodiments, the system sorts each item of inventory in the training dataset classified as “stocked out” or “overstocked” into one or more categories based on the root cause of each stockout or overstock event. In some embodiments, the categories of stockout events may include, but are not limited to: 1) replenishment purchase orders being made too late; 2) one or more large unexpected customer sales depleted inventory; 3) undetected increases in demand of established items; 4) items are low volume and difficult to forecast sales; 5) insufficient stock purchases for strong seasonal pattern; 6) insufficient stock purchases for promotions; 7) late or short shipment from vendor; and/or 8) new items are selling more than forecasted. In one or more embodiments, the categories of overstock events may include, but are not limited to: 1) excess inventory purchased due to Vendor Minimum; 2) Vendor offered “deal” or discount which caused excess purchase; 3) undetected decreases in demand of established items; 4) items are low volume and difficult to forecast sales; 5) Pack size (e.g., case of 100) caused excess purchase (e.g., only needed 3 units); 6) overly ambitious stock purchases for promotions; 7) early or surplus shipment from vendor; and/or 8) new items are selling less than expected. In particular embodiments, the system's classification engine analyzes the inventory data (e.g., inventory count, sales volume, transaction history, etc.) of the training dataset to facilitate sorting the training dataset into one of the categories described above. In one or more embodiments, the training dataset may be manually sorted into one of the categories described above. In certain embodiments, the system is configured to store the results of the second sort in a database.

At step 408, the results produced by the trained model are evaluated and checked for accuracy and consistency. In some embodiments, the results produced by the trained model are evaluated using an evaluation set, which is generally a subset of the training datasets. In particular embodiments, the evaluation set includes inventory data that has been modified to include a label or marker for indicating which categories a particular inventory item should be sorted in (e.g., “stocked out” and “insufficient stock purchase for promotions,” or “overstocked” and “undetected decrease in demand of established items,” or “appropriately stocked,” or any other appropriate combination of categories). In at least one embodiment, the evaluation set facilitates accurate comparisons of how the inventory data is actually sorted versus how the inventory data should be sorted.

In various embodiments, at step 410, the system is configured to determine whether the model has been sufficiently trained or if the model needs to undergo further training. In particular embodiments, if the trained model returns a sorting accuracy within a predetermined confidence level or threshold (e.g., one percent, two percent, five percent, ten percent, etc.), then the results “match” and the system is configured to approve the model for operation and the process terminates. In these embodiments (and others), if the trained model returns a sorting accuracy outside of the predetermined confidence level, then the results do not match and the system is configured to cycle back to step 406 and retrain the machine learning model. In certain embodiments, this cycle will repeat itself until step 410 returns an indication that the trained model is approved for operation (i.e., returns a sorting accuracy within a predetermined threshold level). An acceptable threshold level can be determined by a system user or set as a default parameter of the system according to various preferences. In various embodiments, the model may be trained and generated using one or more categories of stockouts and overstocks, and one or more labels of exemplary stockouts and overstocks.

Now referring to FIG. 5, an exemplary inventory optimization machine learning model operational process 500 in operation is shown, according to one embodiment of the present disclosure. In various embodiments, the steps and processes described in FIG. 5 may occur after the machine learning model has been initiated (as shown and described in relation to FIG. 3) and trained (as shown and described in relation to FIG. 4). In at least one embodiment, the steps and processes described in FIG. 5 may occur as a standalone process. The steps and processes shown and described in FIG. 5 begin at step 502, where the system is configured to receive inventory data. In particular embodiments, the inventory data is received from a third-party inventory management tool (e.g., an ERP tool). In one or more embodiments, the inventory data may be generated by the system (e.g., the system is configured to store and manage inventory operational data). In at least one embodiment, the inventory data received by the system includes, but is not limited to: inventory type, product name, product description, quantity, location, days on hand, price, cost, number of units sold, last stockout event, last overstock event, lead time for replenishment, historical inventory data, and any other suitable information relevant to the systems and methods described herein.

At step 504, the system is configured to normalize and format the inventory data. Data received by third-party systems may not be compatible with data constructs employed by the system. Thus, in various embodiments, the inventory data is cleaned (e.g., normalized) to remove any extraneous information not required by the systems and processes described herein. In particular embodiments, the normalized data is also reformatted into a standard format that is compatible with the data constructs employed by the system. In at least one embodiment, the system performs feature extraction on the reformatted data to convert the data into a set of features (e.g., inputs) suitable for the machine learning model. In one or more embodiments, feature extraction includes identifying and extracting stockout and overstock data (e.g., date of stockout or overstock event, last fulfilled order, next scheduled order, last sale, etc.).

At step 506, the system applies the reformatted inventory data to the trained model for processing and sorting. In these embodiments (and others), the model analyzes the inventory data to identify and then sort potential stockouts and/or overstocks. In certain embodiments, the model may analyze the item count and historical sales figures to facilitate this initial sort. In particular embodiments, the model analyzes a variety of facets of the inventory data to determine whether each inventory item is a stockout or an overstock (or neither).

In various embodiments, the model sorts the potential stockouts or overstocks into one or more defined categories. In at least one embodiment, the one or more defined categories comprise various reasons (or root causes) for stockouts or overstocks. In particular embodiments, the model is configured to analyze the inventory data and determine the reason that an inventory item is stocked out or overstocked and then sort the inventory item into the appropriate category.

At step 508, upon completion of the inventory data sort, the system is configured to generate an output report. In various embodiments, the output report may include the results of the inventory sorted into its respective categories such that a user can clearly see the reasons that caused each identified stockout or overstock event to occur. Further, in one or more embodiments, the output report may include alerts and/or recommendations generated by the system with supporting information about the reason for each item and/or location that had an inventory issue.

Upon completion of the machine learning inventory optimization process, a user may desire to retrain the model using the inventory data processed and output by the system at step 508. In these embodiments (and others), at step 510, the system is configured to perform a check as to whether the user desires to retrain the model or terminate the process. If the user does not decide to retrain the model then the process will terminate. If the user decides to retrain the model with the inventory data as sorted and output at step 510, then the system is configured to cycle back to step 406 of FIG. 4 to retrain the machine learning model. In at least one embodiment, the system is configured to automatically retrain the model based on the resultant data set. In these embodiments (and others), the system is continually learning and improving its performance as more data is processed.

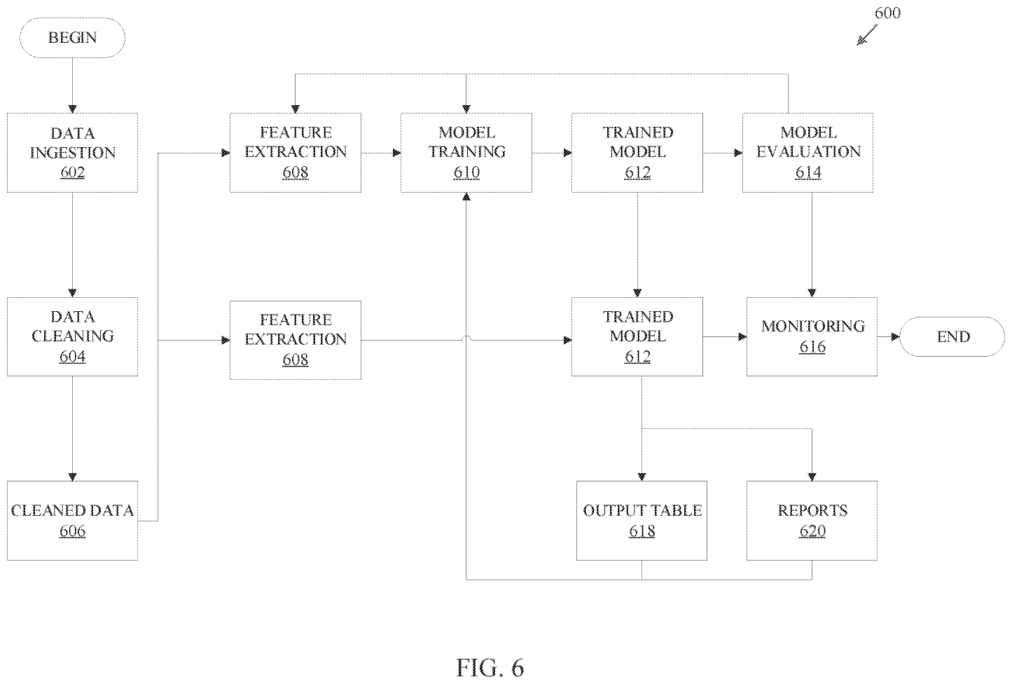

Turning now to FIG. 6, an exemplary machine learning inventory optimization process 600 is shown, according to one embodiment of the present disclosure. The embodiment shown in FIG. 6 discloses a comprehensive flow chart depicting one alternative explanation of some of the processes shown and described earlier in connection with FIGS. 4 and 5. In various embodiments, the exemplary process 600 begins at step 602 with data ingestion. As described above, in one or more embodiments, data ingestion refers to the system intaking new inventory data to be processed, such that the root cause of any stockout or overstock events can be identified.

In some embodiments, the exemplary process 600 continues at step 604 with data cleaning. In particular embodiments, data cleaning refers to the system normalizing and reformatting the ingested inventory data such that the inventory data is compatible with system requirements and additional processing can be done. In particular embodiments, the system outputs the cleaned data at step 606.

At step 608, the system is configured to perform feature extraction. In various embodiments and as discussed above, feature extraction refers to the system converting the cleaned data into a set of features (e.g., inputs) suitable for the machine learning model. Generally, in particular embodiments, feature extraction is the process where unnecessary data is removed from the cleaned inventory data prior to feeding the data to the machine learning model. In certain embodiments, the set of features extracted may include, but is not limited to: PO Issue Date, PO Receipt Date, daily Onhand Units, Daily Forecast Quantity, Vendor Minimum, and other similar features. In these embodiments (and others), feature extraction facilitates efficient and more accurate machine learning processing.

In some embodiments, at step 610, the system may transmit the extracted features to the model training module for training the machine learning model. In one or more embodiments, the model is trained using one or more training datasets. In various embodiments, the model is trained to first sort the inventory data into three categories (stocked out inventory, overstocked inventory, and appropriately stocked inventory). After the initial sort, in particular embodiments, the model is then trained to sort the stocked out inventory and the overstocked inventory into various categories that represent the reason (i.e., root cause) for the stockout or overstock event. In particular embodiments, the system outputs the trained model at step 612. In at least one embodiment, the system may transmit the inventory features extracted at step 608 directly to the trained model for processing and sorting. In these embodiments (and others), the system is configured to bypass the step of training the model at step 610.

In certain embodiments, at step 614, the system is configured to evaluate the trained model. In particular embodiments, the model is evaluated by comparing the sorted results of the trained model to the known (or expected) results. In various embodiments, if the machine learning model does not pass evaluation (e.g., the sorting accuracy of the model was not within a predetermined confidence level), then the sorted data is cycled back into the system for further training (e.g., at steps 608 and 610). In particular embodiments, if the machine learning model passes the evaluation (e.g., the sorting accuracy of the model was within a predetermined confidence level), the system is configured to monitor the model at step 616. In particular embodiments, the system may be configured to monitor the trained model without an evaluation. In at least one embodiment, the system continually monitors performance and re-trains the model if performance has shown degradation.

In at least one embodiment, at steps 618 and 620, the system is configured to output the results to an output table (at step 618) and/or a report (at step 620). In particular embodiments, the output reports and/or tables may be generated in any suitable format (e.g., spreadsheet, word document, graph, chart, etc.). In particular embodiments, the reports and output tables includes at least the inventory data sorted into its respective initial category (e.g., stocked out or overstocked) and its respective subsequent category (e.g., “one or more large unexpected customer sales depleted inventory” or “items are low volume and difficult to forecast sales”). In one or more embodiments, the reports and/or output tables may be transmitted back to the model training module at stop 610, such that the inventory data may be recycled back through the system for additional training, evaluation, and adjustment of the machine learning methodology employed.

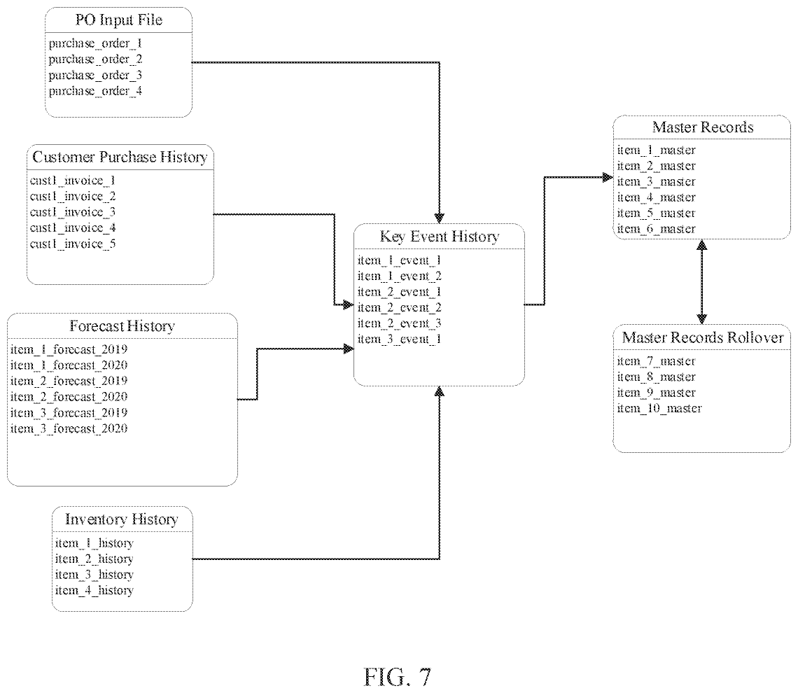

Now referring to FIG. 7, an exemplary data schema is shown, according to one embodiment of the present disclosure. In particular embodiments, the system may be initiated and trained using data from several data tables. In various embodiments, the system may initiate using data from any suitable number of data tables (e.g., one, five, seven, twelve, twenty-five, etc.). According to the embodiment shown in FIG. 7, the system is initiated using data from seven data tables. In some embodiments, various rows of the seven data tables are joined to form one or more data combinations. In certain embodiments, the system may normalize the data in the seven data tables such that formatting is consistent across multiple data sources. In particular embodiments, the seven data tables may be joined on item number, stock location, date, or any other suitable row of data. In particular embodiments, and as shown in the data schema of FIG. 7, the system may include, but is not limited to, the following data tables: a purchase order input file data table for storing historical data pertaining to purchase orders placed per item per location; a customer purchase history data table for storing the purchase history by customer of items per location; a forecast history data table for storing the forecast history per item per location; an inventory history data table for storing historical data pertaining to each inventory item at each location, a key event history data table for storing historical data pertaining to key events of each item at each location, and one or more master record data tables for storing the master data of each item. In particular embodiments, master data may include various types of data including, but not limited to, sales data, inventory counts, forecast data, customer data, vendor ID, unit cost, unit sell, open PO's and any other data suitable to facilitate the systems and methods described herein.

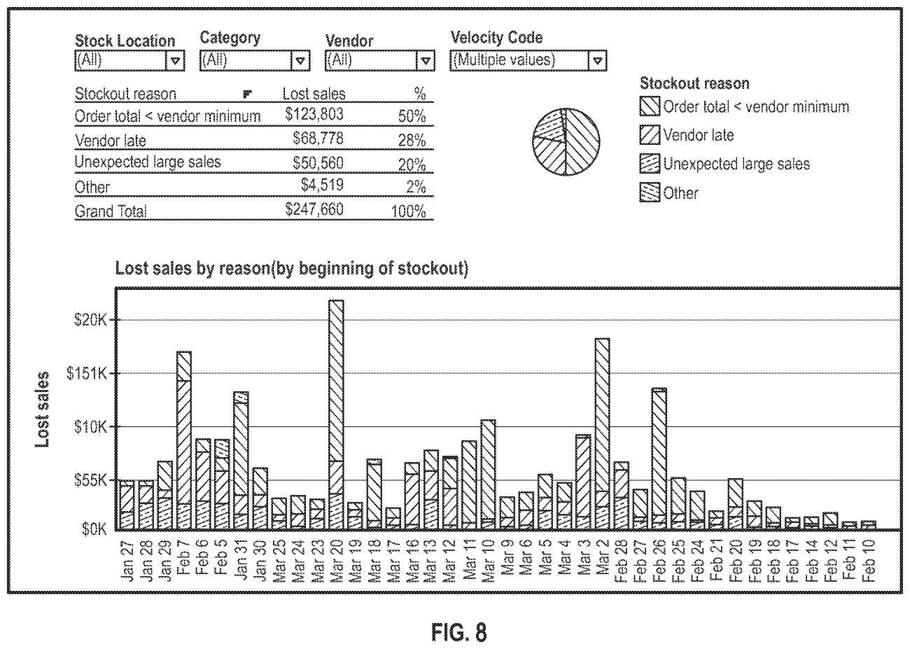

FIGS. 8-10 illustrate screenshots of an exemplary interface that a user of the system may use to manage the system and review outputted data, according to various embodiments of the present disclosure. As may be understood from the figures, a user interface may include useful information regarding stock events, including but not limited to: a visual breakdown of the various reasons for stock events, the per item cost associated with each particular stock event (i.e., the lost sales), the number of inventory items subject to a stock event, the description of items subject to a stock event, and other suitable pieces of information.

FIG. 8 illustrates an exemplary user interface home screen, according to one embodiment of the present disclosure. In various embodiments, and as shown in FIG. 8, the user interface of the system may include one or more graphs for visually breaking down the identified stock events. In the embodiment shown in FIG. 8, the system may include a graph that depicts the amount of lost sales per stock event reason. In certain embodiments, the interface may display various other graphs that may be useful to a user (e.g., a graph depicting the type of inventory per stock event, a graph depicting the amount of lost sales per type of inventory, etc.). In at least one embodiment, a user may choose the type of graph displayed on the interface. In some embodiments, the system chooses the type of graph displayed on the interface.

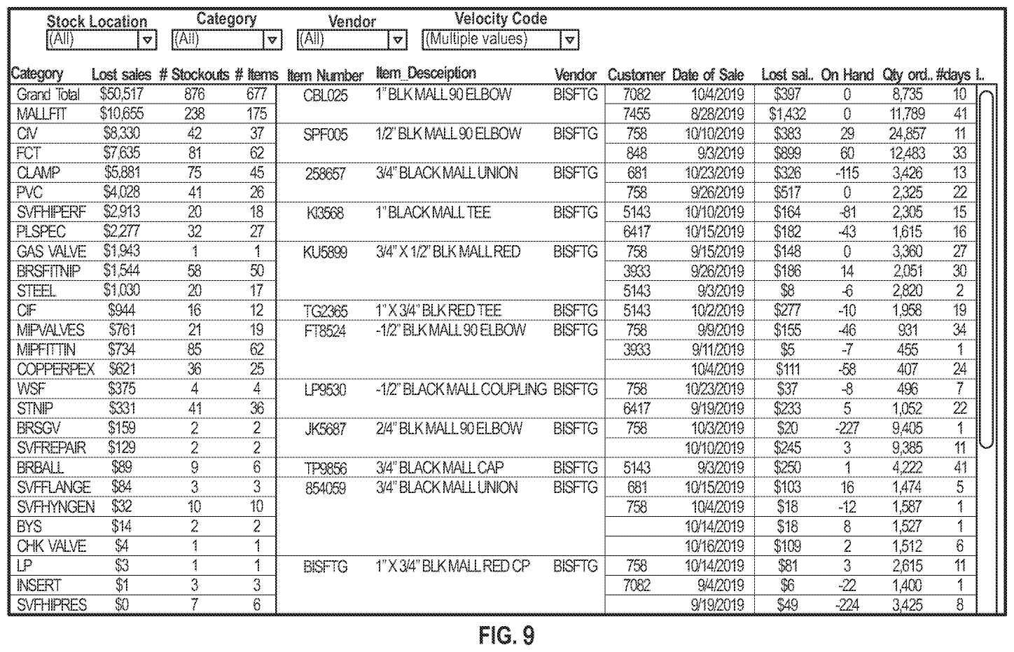

FIG. 9 illustrates an exemplary user interface, according to one embodiment of the present disclosure. In various embodiments, the interface may display a chart of information relevant to the stock events identified by the system. In some embodiments, and as shown in FIG. 9, the system may display a chart organized by category of inventory. In particular embodiments, the chart may include item descriptions, dates of sale, lost sales amount, and other suitable pieces of information.

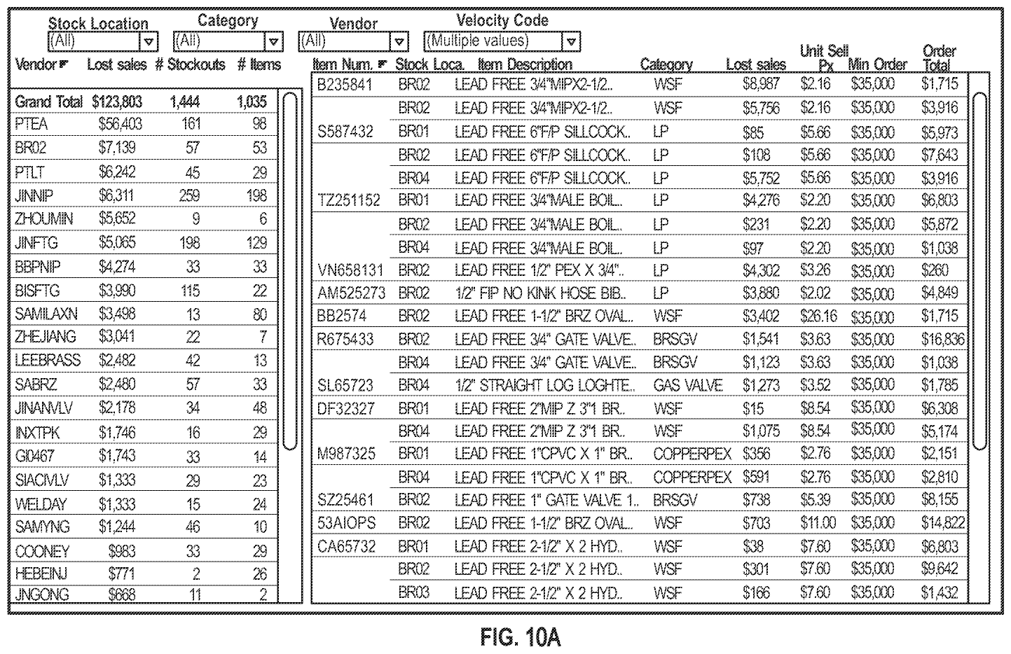

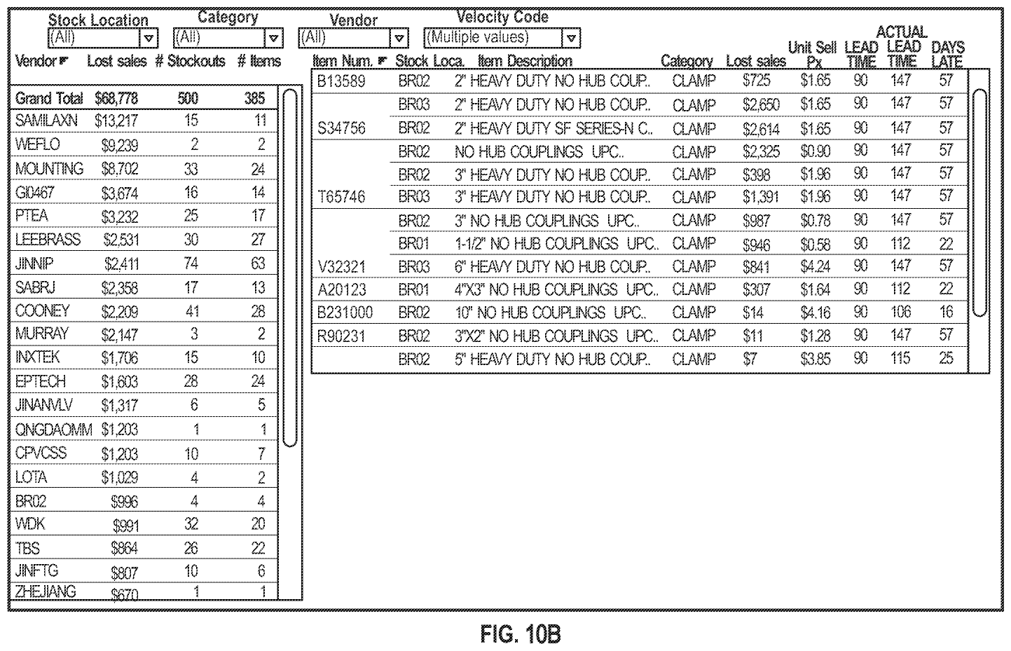

FIGS. 10A and 10B illustrate exemplary user interfaces, according to one embodiment of the present disclosure. In one or more embodiments, and as shown in FIGS. 10A and 10B, the system may display a chart organized by vendors of inventory. In particular embodiments, the chart may include item descriptions, dates of sale, lost sales amount, purchase order totals, scheduling and/or delivery details, and other suitable pieces of information.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions include, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program engines, as described earlier, being executed by computers in networked environments. Such program engines are often reflected and illustrated by flow charts, sequence diagrams, exemplary screen displays, and other techniques used by those skilled in the art to communicate how to make and use such computer program engines. Generally, program engines include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program engines represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program engines may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program engines, and other data for the computer.

Computer program code that implements the functionality described herein typically includes one or more program engines that may be stored on a data storage device. This program code, as is known to those skilled in the art, usually includes an operating system, one or more application programs, other program engines, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program engines depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed technology will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the technology to the precise forms disclosed. Many modifications and variations are possible in light of the above teaching.

The embodiments were chosen and described in order to explain the principles of the technology and their practical application so as to enable others skilled in the art to utilize the technology and various embodiments and with various modifications as are suited to the particular use contemplated. Alternative embodiments will become apparent to those skilled in the art to which the technology pertains without departing from their spirit and scope. Accordingly, the scope of the present technology will ultimately be defined by the claims in any resulting issued patent rather than the foregoing description and the exemplary embodiments described therein.

What is claimed is:

1. A method of managing product inventory levels comprising:
receiving an operational dataset of inventory data, wherein the operational dataset comprises a plurality of items stocked or to be stocked with a particular entity;
retrieving a machine learning model, the machine learning model comprising a plurality of categories of stock events;
applying the machine learning model to the operational dataset of inventory data to associate each of the plurality of items in the operational dataset with a respective category of the plurality of categories of stock events; and
generating an output comprising results of the application of the machine learning model to the operational dataset.

2. The method of claim 1, further comprising:
associating each of the plurality of items in the operational dataset with the respective category of the plurality of categories of stock events; and
training the machine learning model based on the operational dataset of inventory data.

3. The method of claim 2, further comprising determining an efficacy of the machine learning model after further training the machine learning model with the operational dataset of inventory data

4. The method of claim 3, wherein the efficacy is a measure of deviation between the pre-associated category of stock events to the estimated category of stock events, and an acceptable efficacy comprises a margin of error below a predefined threshold for the deviation.

5. The method of claim 1, wherein the stock events are selected from the group comprising: stockouts, overstocks and appropriately stocked.

6. The method of claim 5, wherein one or more respective categories of the plurality of categories are associated with one or more reasons for stock events.

7. The method of claim 6, wherein the plurality of categories include one of a first plurality of category subsets selected from the group comprising:
stockouts;
overstocks; and
appropriately stocked.

8. The method of claim 7, wherein the first plurality of category subsets further comprise one of a second plurality of category subsets comprising the one or more reasons for stock events.

9. The method of claim 8, wherein the one or more reasons for stock events are selected from the group comprising:
replenishment orders for new items to be stocked with the particular entity made too late;
one or more large unexpected customer sales depleted items stocked with the particular entity;
undetected increases in demand of established items stocked with the particular entity;
items stocked or to be stocked with the particular entity are low volume and difficult to forecast sales;
purchase orders for items stocked or to be stocked are insufficient for strong seasonal pattern;
purchase orders for items stocked or to be stocked are insufficient for promotions;
late or short shipment of items to be stocked at particular location;
new items stocked are selling more than forecasted;
one or more items stocked were purchased in excess of forecast due to vendor minimums;
one or more items stocked were purchased in excess of forecast due to vendor promotions;
undetected decreases in demand of established items stocked with a particular entity;
purchase orders for items stocked or to be stocked are packaged in quantities in excess of forecast;
purchase orders for items stocked or to be stocked are overly ambitious for promotions;
early or surplus shipment from vendor of items to be stocked at particular location; and
new items stocked are selling less than expected.

10. The method of claim 9, further comprising:
retrieving the stock event reason for each of the plurality of items in the operational dataset; and
generating a recommendation for resolving the stock event reason.

11. The method of claim 10, further comprising:
integrating with a third party ordering system and initiating an inventory order based on the recommendation generated.

12. The method of claim 1, wherein the output comprises a printable report or a display on a graphical user interface of a computing device.

13. A system for managing product inventory levels comprising:
a database configured to store inventory data;
a processor; and
a non-transitory computer-readable medium having instructions stored thereon, the instructions executable by the processor for performing operations comprising:
receiving an operational dataset of inventory data from the database, wherein the operational dataset comprises a plurality of items stocked or to be stocked with a particular entity;
retrieving a machine learning model, the machine learning model comprising a plurality of categories of stock events;
applying the machine learning model to the operational dataset of inventory data to associate each of the plurality of items in the operational dataset with a respective category of the plurality of categories of stock events; and
generating an output comprising results of the application of the machine learning model to the operational dataset.

14. The system of claim 13, wherein the processor is further configured for:
associating each of the plurality of items in the operational dataset with the respective category of the plurality of categories of stock events; and
training the machine learning model based on the operational dataset of inventory data.

15. The system of claim 14, wherein the processor is further configured for determining an efficacy of the machine learning model after further training the machine learning model with the operational dataset of inventory data

16. The system of claim 15, wherein the efficacy is a measure of deviation between the pre-associated category of stock events to the estimated category of stock events, and an acceptable efficacy comprises a margin of error below a predefined threshold for the deviation.

17. The system of claim 13, wherein the stock events are selected from the group comprising: stockouts, overstocks and appropriately stocked.

18. The system of claim 17, wherein one or more respective categories of the plurality of categories are associated with one or more reasons for stock events.

19. The system of claim 18, wherein the plurality of categories include one of a first plurality of category subsets selected from the group comprising:
stockouts;
overstocks; and
appropriately stocked.

20. The system of claim 19, wherein the first plurality of category subsets further comprise one of a second plurality of category subsets comprising the one or more reasons for stock events.

21. The system of claim 20, wherein the one or more reasons for stock events are selected from the group comprising:
replenishment orders for new items to be stocked with the particular entity made too late;
one or more large unexpected customer sales depleted items stocked with the particular entity;
undetected increases in demand of established items stocked with the particular entity;
items stocked or to be stocked with the particular entity are low volume and difficult to forecast sales;
purchase orders for items stocked or to be stocked are insufficient for strong seasonal pattern;
purchase orders for items stocked or to be stocked are insufficient for promotions;
late or short shipment of items to be stocked at particular location;
new items stocked are selling more than forecasted;
one or more items stocked were purchased in excess of forecast due to vendor minimums;
one or more items stocked were purchased in excess of forecast due to vendor promotions;
undetected decreases in demand of established items stocked with a particular entity;
purchase orders for items stocked or to be stocked are packaged in quantities in excess of forecast;
purchase orders for items stocked or to be stocked are overly ambitious for promotions;
early or surplus shipment from vendor of items to be stocked at particular location; and new items stocked are selling less than expected.

22. The system of claim 21, wherein the processor is further configured for:
retrieving the stock event reason for each of the plurality of items in the operational dataset; and
generating a recommendation for resolving the stock event reason.

23. The system of claim 22, wherein the processor is further configured for:
integrating with a third party ordering system and initiating an inventory order based on the recommendation generated.

24. The system of claim 13, wherein the output comprises a printable report or a display on a graphical user interface of a computing device.

25. A non-transitory computer-readable medium having program code that is stored thereon, the program code executable by one or more processing devices for performing operations comprising:
receiving an operational dataset of inventory data from the database, wherein the operational dataset comprises a plurality of items stocked or to be stocked with a particular entity;
retrieving a machine learning model, the machine learning model comprising a plurality of categories of stock events;
applying the machine learning model to the operational dataset of inventory data to associate each of the plurality of items in the operational dataset with a respective category of the plurality of categories of stock events; and
generating an output comprising results of the application of the machine learning model to the operational dataset.
